(19) United States
(12) Patent Application Publication
(10) Pub. No.: US 2026/0168714 A1
(43) Pub. Date: Jun. 18, 2026

(54) Fluid seal system, fluid circuit, and method

(71) Applicant: ETO MAGNETIC GmbH, Stockach (DE)

(72) Inventors: Peter Vincon, Stockach (DE); Yannick Goos, Allensbach (DE); Patrick Moll, Mengen-Rulfingen (DE); Timo Rigling, Moos (DE); Michael Feindler, Stockach (DE)

(21) Appl. No.: 18/707,851

(22) PCT Filed: Nov. 4, 2022
(86) PCT No.: PCT/EP2022/080841

§ 371 Date: May 6, 2024

(30) Foreign Application Priority Data
Nov. 8, 2021 (DE) 10 2021 129 029.5
Feb. 11, 2022 (DE) 10 2022 103 227.2

(51) Int. Cl. F25B 49/02; F16L 19/02

(52) U.S. Cl. CPC F25B 49/02; F16L 19/02

(57) ABSTRACT

A fluid sealing system includes at least one functional component comprising at least one fluid receiving body which has at least one fluid inlet opening and/or fluid outlet opening, further includes at least one carrier component which has at least one fluid channel comprising at least one fluid channel inlet opening and/or fluid channel outlet opening, which is configured to carry at least the functional component and which has at least one, in particular at least substantially trough-like, receiving depression for at least substantially precisely fitting accommodation of the functional component, and also includes at least one sealing component which forms sealing surfaces and which is configured to establish fluid tightness of a connection between the fluid inlet opening and/or fluid outlet opening and the fluid channel inlet opening and/or fluid channel outlet opening by means of the sealing surfaces,
wherein at least the sealing surfaces of the sealing component bear exclusively against surfaces of the functional component, in particular of the fluid receiving body, and of the carrier component, which are free of separating burrs and separating planes.

### CROSS-REFERENCE TO RELATED APPLICATIONS

This patent application is a U.S. national stage application of international patent application PCT/EP2022/080841, filed on Nov. 4, 2022, which is based on and claims priority to German patent application DE 10 2021 129 029.5, filed on Nov. 8, 2021, the contents of which are incorporated herein by reference.

### PRIOR ART

The invention relates to a fluid sealing system, a fluid cycle and a method.

Fluid sealing systems by means of which functional components are connected to fluid channels are already known.

The objective of the invention is in particular to provide a generic device having advantageous properties with respect to tightness. The objective is achieved according to the invention.

### ADVANTAGES OF THE INVENTION

The invention is based on a fluid sealing system with at least one functional component comprising at least one fluid receiving body which has at least one fluid inlet opening and/or fluid outlet opening, with at least one carrier component which has at least one fluid channel comprising at least one fluid channel inlet opening and/or fluid channel outlet opening, which is configured to carry at least the functional component and which has at least one, in particular at least substantially trough-like, receiving depression for at least substantially precisely fitting accommodation of the functional component, and with at least one sealing component which forms sealing surfaces and which is configured to establish fluid tightness of a connection between the fluid inlet opening and/or fluid outlet opening and the fluid channel inlet opening and/or fluid channel outlet opening by means of the sealing surfaces.

It is proposed that at least the sealing surfaces of the sealing component bear exclusively against surfaces of the functional component, in particular of the fluid receiving body, and of the carrier component, which are free of separating burrs and separating planes. As a result, good tightness is advantageously achievable. Advantageously, a seal having a long service life can be obtained.

Advantageously, damage to the sealing component during installation and/or de-installation by scraping along separating burrs or separating planes can be avoided. A fluid sealing system is in particular configured to enable at least substantially leakage-free transport of an, in particular gaseous and/or liquid, fluid between two components.

A “functional component” is in particular to mean a component which at least influences or analyzes a flow of the fluid. For example, the functional component may be realized as a fluid sensor, such as a fluid pressure sensor or a flow-rate sensor, as a pump, as a heat exchanger, as an expansion valve, in particular of a refrigeration cycle or of a cooling cycle, as a changeover valve, in particular of a refrigeration cycle or of a cooling cycle, or preferentially as a water valve, such as a changeover valve, mixing valve or regulating valve. In particular, the fluid receiving body may be realized as a switchable flow-through region of a fluid valve, as a pumping region of a pump, as a measuring region of a fluid sensor or as a flow-through region of a heat exchanger. The fluid inlet opening and/or fluid outlet opening of the fluid receiving body is here in particular to be understood as the subregion of the fluid receiving body in which the fluid can flow into a fluid receiving space of the fluid receiving body or can flow out of the fluid receiving space of the fluid receiving body. It is conceivable that the fluid receiving body comprises more than one fluid inlet opening and/or fluid outlet opening, for example two, three, four or five fluid inlet openings and/or fluid outlet openings.

By a “carrier component” is in particular a component to be understood which holds at least one, preferably more than one, functional component. For example, the carrier component may be realized as a carrier plate. In particular, the carrier component may be realized in one piece or in multiple parts. The carrier component is preferably implemented in two parts, wherein one part forms fluid channels open directly in one direction (for example in a trough-like manner) and a further part closes these fluid channels (like a cover). The carrier component thus preferably realizes the fluid channels in a one-part implementation. Alternatively, however, fluid channels realized separately from the carrier component and fastened to the carrier component are likewise conceivable. The fluid channel inlet opening and/or fluid channel outlet opening of the fluid channel is here in particular to be understood as an end region or as a branching region of the fluid channel, in which the fluid can flow into a fluid receiving space of the fluid channel or can flow out of the fluid receiving space of the fluid channel. It is conceivable for the fluid channel to comprise more than one fluid inlet opening and/or fluid outlet opening, for example two, three, four or five fluid inlet openings and/or fluid outlet openings. The fluid channel preferably connects at least two functional components of a common fluid cycle, for example a refrigeration cycle or a cooling cycle. In particular, the carrier component forms a plurality of fluid channels which are separate from one another.

An “at least substantially trough-like” shape is in particular to mean a shape which forms a boundary on a first side (underside) and forms a boundary on at least two sides (side walls) adjoining this first side. The at least substantially trough-like shape is preferentially open on a side (upper side) opposite the first side. “Substantially precisely fitting” is in particular to mean precisely fitting within manufacturing tolerances and/or press-fit tolerances and/or transition-fit tolerances. The sealing component is in particular made of a fluid-impermeable material. The sealing component is in particular made of an elastic material, like for example a rubber. The sealing component is preferably realized separately from the functional component. The sealing component is preferably realized separately from the carrier component. The sealing surfaces are in particular formed by the regions of the sealing component which bear sealingly against in each case one surface of the components which are to be sealed with respect to one another, like in each case one surface of the functional component and of the carrier component.

Separating burrs or separating planes arise during the injection-molding process, in particular during the de-molding of injection-molded parts, in places where the injection-molding tools meet and/or where injection-molding slides detach. Separating burrs or separating planes may produce small unevennesses or roughnesses on the surfaces of the injection-molded parts. “Configured” is in particular to mean specifically programmed, designed and/or equipped. An object being configured for a specific function is in particular to mean that the object fulfills and/or carries out this specific function in at least one application state and/or operation state.

If the fluid receiving body and/or the carrier component are produced as, in particular one-piece, injection-molded parts, an advantageously simple and/or cost-effective production in large numbers of pieces is enabled. Moreover, a complexity of the fluid sealing system can be kept as low as possible. In particular, the sides of the fluid receiving body with the fluid inlet openings and/or fluid outlet openings can be de-molded by respectively one injection-molding slide. “One-piece” is advantageously to mean formed in one piece, for example by production from a cast and/or by production in a single-component or multi-component injection-molding procedure, and advantageously from a single blank. In particular, at least the side of the fluid receiving body which has the fluid inlet opening and/or fluid outlet opening is de-molded by an injection-molding slide, such that preferably no separating planes will arise on this side. Preferentially, all sides of the fluid receiving body which have fluid inlet openings and/or fluid outlet openings are de-molded with respectively one slide.

It is also proposed that the functional component, in particular the fluid receiving body, and the carrier component are realized so as to be separable from one another in a non-destructive manner. This advantageously allows achieving increased operating comfort and assembly comfort. Advantageously, separate testing of the functional component independently of the carrier component is enabled. Advantageously, simple exchange of functional components, e.g. for maintenance, repair, etc., is enabled. In particular, the functional component, preferably the fluid receiving body, and the carrier component are free of common components/structural parts. In particular, the functional component, preferably the fluid receiving body, and the carrier component are free of gluings, weldings, solderings or the like. In particular, the fluid receiving body is realized differently and separately from the receiving depression of the carrier component.

Furthermore, it is proposed that the functional component, in particular the fluid receiving body, is pressed into the carrier component. As a result, simple assembly is advantageously enabled. Advantageously, high tightness is achievable. In particular, during the pressing in, the sealing component is (elastically) deformed, thus sealing a connection between the fluid inlet opening and/or fluid outlet opening of the functional component and the fluid channel inlet opening and/or fluid channel outlet opening of the fluid channel. After the pressing in, the functional component is fastened to the carrier component in the pressed-in state, i.e. in the state in which the sealing component is elastically deformed. In particular, during the pressing into the carrier component, the functional component is pressed in with a pressing force, wherein there is, however, no classic press fit.

It is further proposed that the fluid inlet opening and/or fluid outlet opening of the fluid receiving body is arranged laterally with respect to a (designated) fitting direction/a (designated) pressing-in direction, along which the functional component is installed/pressed into the carrier component, and/or is arranged laterally with respect to a normal direction of a main extension plane of the carrier component. This advantageously allows ensuring high compactness of a fluid cycle having the fluid sealing system. In particular, the fitting direction is realized as an average movement direction, along which the functional component moves during the pressing into the carrier component. In particular, the fitting direction runs parallel to a normal direction of an opening plane which is formed by the receiving depression and through which the functional component is introduced into the receiving depression during assembly of the fluid sealing system. A “main extension plane” of a structural unit is in particular to mean a plane which is parallel to a largest side surface of a smallest imaginary cuboid which just still completely surrounds the structural unit, and in particular extends through the center of the cuboid. The expression “laterally” preferably also comprises obliquely lateral arrangements of the fluid inlet opening and/or fluid outlet opening.

In addition, it is proposed that an opening plane of the fluid inlet opening and/or fluid outlet opening of the fluid receiving body is angled relative to a (designated) fitting direction/a (designated) pressing-in direction along which the functional component is installed/pressed in the carrier component, and/or is angled relative to a normal direction of a main extension plane of the carrier component. As a result, a sealing effect is advantageously producible by the pressing-in. Advantageously, favorable tightness is achievable. In addition, self-centering of the functional component in the receiving depression of the carrier component is advantageously achievable. The opening plane of an opening is in particular formed by the side walls bordering the opening. In particular, openings whose edge is not completely even also have an opening plane, which in this case is preferably formed by the imaginary plane which, viewed over the entire edge of the opening, has the smallest overall deviation from the real contour of the edge. If an angle spanned by the opening plane and the fitting direction and/or the normal direction is between 2.5° and 22.5°, preferably between 5° and 15°, advantageously good tightness is achievable during the pressing-in. In addition, self-centering of the functional component in the receiving depression of the carrier component is advantageously achievable. In particular, the fluid receiving body has, in a lateral circumferential direction, a plurality of, preferably mutually adjacent, planar surfaces which are angled relative to the fitting direction/the normal direction in such a way that a conically tapering shape of the functional component results. For example, the fluid receiving body may have four conical surfaces for a simple centering in the carrier component. However, more or less than four conical surfaces are likewise conceivable. In addition, it is also conceivable that the angle included by the opening plane and the fitting direction and/or the normal direction is greater than 22.5°, for example up to 45° or even greater than 45° (but less than 90°).

Furthermore, it is proposed that the fluid receiving body has at least one further fluid inlet opening and/or fluid outlet opening, which is connectable in a fluid-tight manner to at least one further fluid channel inlet opening and/or fluid channel outlet opening of the carrier component or of a further carrier component via a further sealing component of the fluid sealing system in a manner that is at least substantially the same as in the connection of the fluid inlet opening and/or fluid outlet opening with the fluid channel inlet opening and/or fluid channel outlet opening. As a result, advantageously, high tightness of the fluid connections of valves and/or pumps used in the carrier component is achievable.

If in such a case a further fluid inlet opening and/or fluid outlet opening is open to a side of the fluid receiving body which is different from a side of the fluid receiving body to which the fluid inlet opening and/or fluid outlet opening is open, high compactness is advantageously achievable. Alternatively or additionally, however, it is also conceivable that two or more fluid inlet openings and/or fluid outlet openings realized separately from one another are arranged simultaneously on a side of the fluid receiving body. Therefore it is proposed, alternatively or additionally, that a further fluid inlet opening and/or fluid outlet opening is open to the same side of the fluid receiving body to which the fluid inlet opening and/or fluid outlet opening is also open. The fluid inlet opening and/or fluid outlet opening and the further fluid inlet opening and/or fluid outlet opening may in such a case be situated horizontally in the same plane or in different planes, for example vertically one above the other.

In addition, the sealing component is advantageously realized as an O-ring, as a result of which a good sealing effect, in particular by the pressing-in, is achievable.

In addition, it is proposed that the fluid receiving body is fastened to the carrier component, in particular to a planar side of the carrier component, by means of (non-destructively) releasable connection elements, such as screws or the like. As a result, simple assembly is advantageously enabled. Moreover, non-destructive disassembly is advantageously enabled. In addition, in this way a sealing effect by the pressing-in is advantageously maintainable. Alternatively, however, other connection methods, such as adhesive bonding, welding, soldering, etc., are also conceivable. The releasable connection element could also be a molded-on clip, for example on the carrier component or on the functional component. In particular, the upper side of the carrier component, which is in particular referred to above as a planar surface, may also have a surface which is different from a planar surface.

Beyond this it is proposed that the functional component is realized as a valve, in particular a fluid valve, as a fluid sensor, as a pump or as a heat exchanger, in particular in a fluid cycle, preferably in a refrigeration cycle or in a cooling cycle. As a result, in particular advantageous tightness of a fluid cycle, in particular refrigeration cycle or cooling cycle, is achievable.

It is further proposed that the carrier component is realized as a common functional component carrier, in particular of a fluid cycle, preferably of a refrigeration cycle or of a cooling cycle, comprising at least one further functional component in addition to the functional component. This allows providing advantageous properties for a construction. Moreover, advantageous compactness is achievable in this way.

If moreover the fluid channel is at least partially formed directly by the carrier component, a number of components can advantageously be kept low. In addition, production and/or assembly costs can advantageously be kept low.

Furthermore, a fluid cycle, in particular a refrigeration cycle or a cooling cycle, with a fluid sealing system is proposed, which in particular has advantageous properties with respect to tightness.

In addition, a method for sealing the fluid channel of the carrier component with the fluid receiving body is proposed, wherein in at least one method step the fluid receiving body is pressed into the, in particular at least substantially trough-like, receiving depression of the carrier component, which is connected to the fluid channel, such that sealing surfaces at least of the sealing component, which is arranged obliquely with respect to the fitting direction of the fluid receiving body and the carrier component and encircles the fluid inlet opening and/or fluid outlet opening of the fluid receiving body, bear exclusively against surfaces of the fluid receiving body and of the carrier component, which are free of separating burrs and separating planes. As a result, good tightness is advantageously achievable. Advantageously, a seal having a long service life can be obtained. Advantageously, damage to the sealing component during installation and/or de-installation by scraping along separating burrs or separating planes can be avoided.

The fluid sealing system according to the invention, the fluid cycle according to the invention and the method according to the invention shall herein not be restricted to the above-described application and implementation. In particular, in order to fulfil a functionality described here, the fluid sealing system according to the invention, the fluid cycle according to the invention and the method according to the invention may have a number of individual elements, components and units that differs from a number given here.

### DRAWINGS

Further advantages will become apparent from the following description of the drawings. In the drawings. an exemplary embodiment of the invention is illustrated. The drawings, the description and the claims contain numerous features in combination. Someone skilled in the art will purposefully also consider the features individually and will find further expedient combinations.

In the drawings:

FIG. 1 shows a schematic illustration of a fluid cycle with a carrier component and

FIG. 2 shows a schematic illustration of a functional component realized by way of example as a valve,

FIG. 3 shows a schematic sectional view of the fluid sealing system with the carrier component and one of the functional components,

FIG. 4 shows a schematic side view of the functional component,

FIG. 5a shows a schematic side view of an alternative fluid receiving body of the functional component,

FIG. 5b shows a schematic side view of a further alternative fluid receiving body of the functional component, and

FIG. 6 shows a schematic flow chart of a method for sealing the carrier component with the functional component by means of the fluid sealing system.

### DESCRIPTION OF THE EXEMPLARY EMBODIMENT

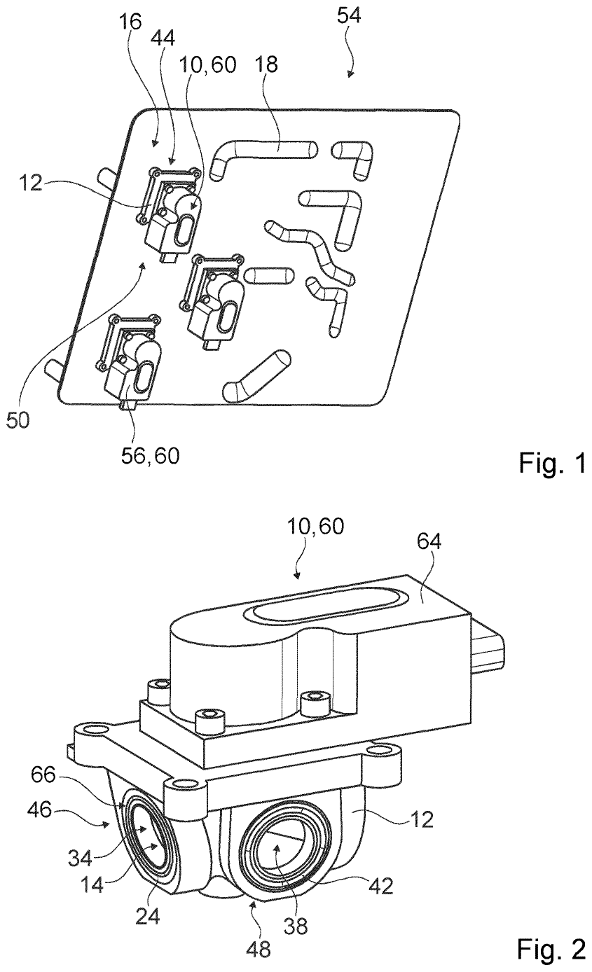

FIG. 1 shows a schematic illustration of a fluid cycle 54. The fluid cycle 54 is realized as a refrigeration cycle or as a cooling cycle, for example of an air-conditioning system. The fluid cycle 54 comprises a fluid sealing system 44. The fluid cycle 54, in particular the fluid sealing system 44, comprises a functional component 10. The functional component 10 is realized as a valve 60. The fluid cycle 54, in particular the fluid sealing system 44, comprises a further functional component 56. The further functional component 56 is realized as a valve 60. The functional component 10 and the further functional component 56 are realized as fluid valves. Alternatively, the functional component 10 and/or the further functional component 56 may also be realized as a fluid sensor, as a pump, as a heat exchanger or as further fluid-conducting functional components of a refrigeration cycle or of a cooling cycle.

The fluid cycle 54, in particular the fluid sealing system 44, comprises a carrier component 16. The carrier component 16 is realized at least substantially in a plate-like manner. The carrier component 16 is realized as a common functional component carrier of the fluid cycle 54. The carrier component 16 is configured to carry/hold the functional component 10. The carrier component 16 is configured to carry/hold the further functional component 56. The common functional component carrier may carry a plurality of identical functional components 10, 56 of the fluid cycle 54. The common functional component carrier may carry different types of functional components of the fluid cycle 54. The functional components 10, 56 are arranged so as to be distributed over both sides of the common functional component carrier. The common functional component carrier, together with the functional components 10, 56, forms a refrigeration cycle module or a cooling cycle module. The carrier component 16 comprises fluid channels 18, 74. The carrier component 16 forms the fluid channels 18, 74 at least partially directly. The fluid channels 18, 74 are realized as elongate depressions in the plate-like carrier component 16. The fluid channels 18, 74 fluidically connect different functional components 10, 56 of the fluid cycle 54 to one another. The carrier component 16 is produced as an injection-molded part. In the present case, the carrier component 16 may be produced as a one-piece injection-molded part, but preferably the carrier component 16 is implemented by at least two one-piece injection-molded parts which are connected to one another. Herein the two one-piece injection-molded parts preferably in each case form a portion of the boundary of the fluid channels 18, 74.

FIG. 2 shows a schematic illustration of a functional component 10 embodied by way of example as a valve 60. However, the fluid sealing system 44 may easily also be transferred to the aforementioned further types of functional components. The functional component 10 comprises a fluid receiving body 12. In the exemplary valve 60, the fluid receiving body 12 may be flowed through optionally in different directions. The valve 60 comprises a valve element 62 (see FIG. 3), which is configured to adjust different flow-through paths through the fluid receiving body 12. The valve 60 comprises a drive unit, which is at least configured to drive and/or control a movement of the valve element 62. The drive unit is fastened, in particular screwed, to the fluid receiving body 12. The fluid receiving body 12 is produced as an injection-molded part. The fluid receiving body 12 is realized in one piece, preferably as one part. The functional component 10 is realized so as to be separable from the carrier component 16 in a non-destructive manner. The fluid receiving body 12 is realized so as to be separable from the carrier component 16 in a non-destructive manner. The fluid receiving body 12 is realized separately from the carrier component 16.

The fluid receiving body 12 comprises a fluid inlet opening and/or fluid outlet opening 14. The fluid inlet opening and/or fluid outlet opening 14 forms an opening plane 34. The fluid receiving body 12 comprises a further fluid inlet opening and/or fluid outlet opening 38. Overall, the fluid receiving body 12 illustrated by way of example in FIG. 2 comprises four fluid inlet openings and/or fluid outlet openings 14, 38, of which only two are visible in FIG. 2. The further fluid inlet opening and/or fluid outlet opening 38 is open to a side 48 of the fluid receiving body 12 which is different from a further side 46 of the fluid receiving body 12 to which the fluid inlet opening and/or fluid outlet opening 14 is open. The fluid inlet openings and/or fluid outlet openings 14, 38 have an at least substantially round opening geometry. Apart from their spatial orientation, the fluid inlet openings and/or fluid outlet openings 14, 38 are realized at least substantially identically to one another. In the injection-molding production procedure, the sides of the fluid receiving body 12 which have a fluid inlet opening and/or fluid outlet opening 14, 38 are in each case formed/de-molded by an injection-molding slide. The sides of the fluid receiving body 12 which have a fluid inlet opening and/or fluid outlet opening 14, 38 are therefore free of demolding burrs, separating burrs and separating planes at least on outer sides of the fluid receiving body 12, in particular at least in regions configured to accommodate a sealing component 24.

The fluid seal system 44 comprises a sealing component 24. The sealing component 24 is made of an elastic material. The sealing component 24 is made of a fluid-sealing material. The sealing component 24 is realized as an O-ring. Each fluid inlet opening and/or fluid outlet opening 14, 38 of the fluid receiving body 12 is in each case assigned a separate sealing component 24. The respective sealing component 24 completely surrounds the respective fluid inlet opening and/or fluid outlet opening 14, 38 in the respective circumferential direction thereof. The fluid receiving body 12 comprises a sealing component receptacle 66. Each of the fluid inlet openings and/or fluid outlet openings 14, 38 of the fluid receiving body 12 is in each case assigned its own sealing component receptacle 66. The sealing component receptacle 66 is configured to receive/hold the sealing component 24. The sealing component receptacle 66 is realized as an at least substantially circular-ring-shaped recess on the outer side of the fluid receiving body 12.

FIG. 3 shows a schematic sectional view of the fluid sealing system 44 in an assembled state, in which the fluid channel 18 of the carrier component 16 is connected in a fluid-tight manner to the fluid receiving body 12 of the functional component 10. The carrier component 16 comprises a receiving depression 22. The receiving depression 22 is realized at least substantially in a trough-like manner. The receiving depression 22 is open to a side of the plate-like carrier component 16. The receiving depression 22 is configured to receive the functional component 10 in an at least substantially precisely fitting manner. The receiving depression 22 is configured to receive the fluid receiving body 12 in an at least substantially precisely fitting manner. The functional component 10 has been introduced into the receiving depression 22. The functional component 10, in particular the fluid receiving body 12, has been pressed into the carrier component 16. In the pressed-in state, the fluid receiving body 12 is fastened to the carrier component 16, in particular to a planar side 50 of the carrier component 16. The fluid receiving body 12 is fastened to the carrier component 16 on the planar side 50 of the carrier component 16 by means of releasable connection elements 52. The fluid receiving body 12 is fixedly screwed to the planar side 50 of the carrier component 16.

The fluid channel 18 comprises a fluid channel inlet opening and/or fluid channel outlet opening 20. The fluid channel inlet opening and/or fluid channel outlet opening 20 is realized as an at least substantially round opening of the fluid channel 18. In the injection-molding production procedure, the fluid channel inlet opening and/or fluid channel outlet opening 20 is de-molded/produced by a single injection-molding slide. The fluid channel inlet opening and/or fluid channel outlet opening 20 overlaps with the fluid inlet opening and/or fluid outlet opening 14. The fluid channel inlet opening and/or fluid channel outlet opening 20 is open towards the fluid inlet opening and/or fluid outlet opening 14 of the fluid receiving body 12. Owing to the corresponding shapes of the receiving depression 22 and of the fluid receiving body 12, advantageous centering of the functional component 10 relative to the fluid channels 18 of the carrier component 16 takes place. The sealing component 24 is elastically compressed during the pressing-in of the functional component 10 into the carrier component 16, as a result of which a sealing effect is advantageously producible. The sealing component 24 forms sealing surfaces 68, 70. The sealing component 24 is configured to establish fluid tightness of a connection between the fluid inlet opening and/or fluid outlet opening 14 and the fluid channel inlet opening and/or fluid channel outlet opening 20 by means of the sealing surfaces 68, 70. A first sealing surface 68 of the sealing component 24 is in the assembled state in sealing contact with the carrier component 16. In the assembled state, the first sealing surface 68 is in sealing contact with only one one-piece part 78 of the carrier component 16. In FIG. 3 the carrier component 16 is implemented by way of example of two parts 78, 80. Herein one of the parts 78 forms a kind of U-shaped boundary of the fluid channel 18. Herein the other one of the parts 80 forms a kind of cover for the U-shaped boundary of the fluid channel 18. In the assembled state, the first sealing surface 68 is in sealing contact with exclusively that part 78 of the carrier component 16 which forms the U-shaped boundary. In the assembled state, a second sealing surface 70 arranged separately from the first sealing surface 68 is in sealing contact with the fluid receiving body 12. The contact surfaces of the fluid receiving body 12 and of the carrier component 16, against which the sealing surfaces 68, 70 of the sealing component 24 bear, are free of demolding burrs, separating burrs and separating planes. The contact surfaces of the fluid receiving body 12 and of the carrier component 16, against which the sealing surfaces 68, 70 of the sealing component 24 bear, are planar (within manufacturing tolerances). The sealing surfaces 68, 70 of the sealing component 24 bear exclusively against surfaces 26, 28 of the functional component 10, in particular of the fluid receiving body 12, and of the carrier component 16, which are free of separating burrs and separating planes.

The carrier component 16 comprises the further fluid channel 74. The further fluid channel 74 comprises a further fluid channel inlet opening and/or fluid channel outlet opening 40. The further fluid inlet opening and/or fluid outlet opening 38 of the fluid receiving body 12 is connectable in a fluid-tight manner to the further fluid channel inlet opening and/or fluid channel outlet opening 40 of the carrier component 16 via a further sealing component 42 of the fluid sealing system 44 in a manner that is at least substantially the same as in the connection of the fluid inlet opening and/or fluid outlet opening 14 of the fluid receiving body 12 with the fluid channel inlet opening and/or fluid channel outlet opening 20 of the fluid channel 18.

The fluid inlet opening and/or fluid outlet opening 14 of the fluid receiving body 12 is arranged laterally with respect to a fitting direction 30, along which the functional component 10 is installed in the carrier component 16. The fluid inlet opening and/or fluid outlet opening 14 of the fluid receiving body 12 is arranged laterally with respect to a pressing direction 72, along which the functional component 10 is pressed into the carrier component 16. The fluid inlet opening and/or fluid outlet opening 14 of the fluid receiving body 12 is arranged laterally with respect to a normal direction 32 of a main extension plane of the carrier component 16.

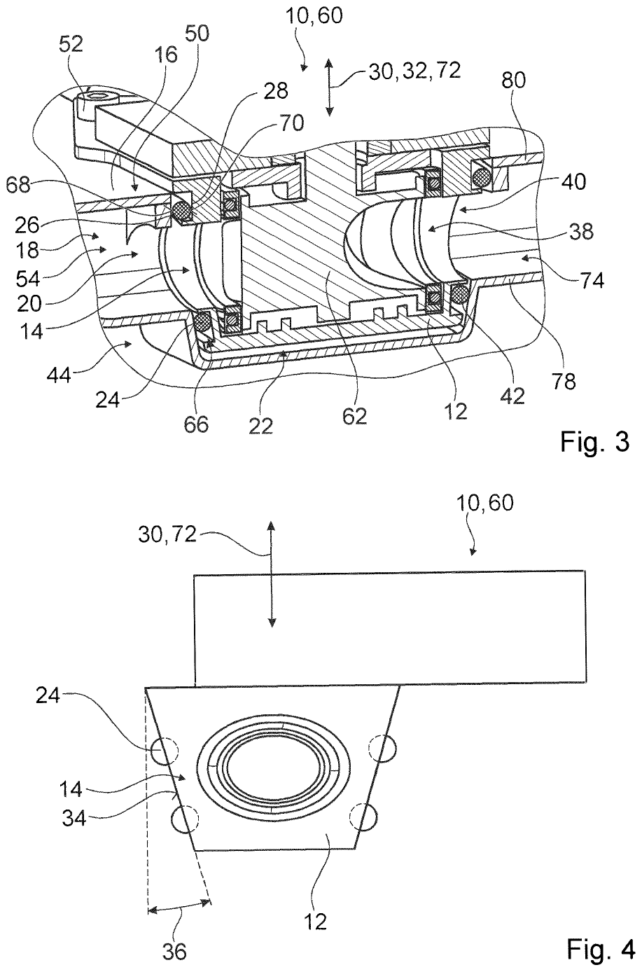

FIG. 4 shows a schematic side view of the functional component 10. The opening plane 34 of the fluid inlet opening and/or fluid outlet opening 14 of the fluid receiving body 12 is angled relative to the fitting direction 30, along which the functional component 10 is installed in the carrier component 16, and/or relative to the pressing direction 72, along which the functional component 10 is pressed into the carrier component 16, and/or relative to the normal direction 32 of the main extension plane of the carrier component 16. An angle 36 spanned by the opening plane 34 and the fitting direction 30 and/or the pressing direction 72 and/or the normal direction 32 is between 5° and 15°. In the assembled state of the fluid sealing system 44, the sealing component 24, in particular a main extension plane of the sealing component 24, is arranged parallel to the opening plane 34. In the assembled state of the fluid sealing system 44, the sealing component 24, in particular the main extension plane of the sealing component 24, is angled relative to the fitting direction 30 and/or relative to the pressing direction 72 and/or relative to the normal direction 32 of the main extension plane of the carrier component 16. An angle 36 spanned by the sealing component 24, in particular the main extension plane of the sealing component 24, and the fitting direction 30 and/or the pressing direction 72 and/or the normal direction 32 in the assembled state of the fluid sealing system 44 is between 5° and 15°. By the oblique arrangement of the opening plane 34 it is achieved that, during the pressing-in of the functional component 10 into the carrier component 16, the sealing component 24 is pressed with its sealing surfaces 68, 70 sealingly against the surfaces 26, 28 of the fluid receiving body 12 and of the carrier component 16. For this purpose, in previously known implementations without angled side walls of the fluid receiving body 12, a pressure perpendicular to the pressing direction 72 must be additionally generated.

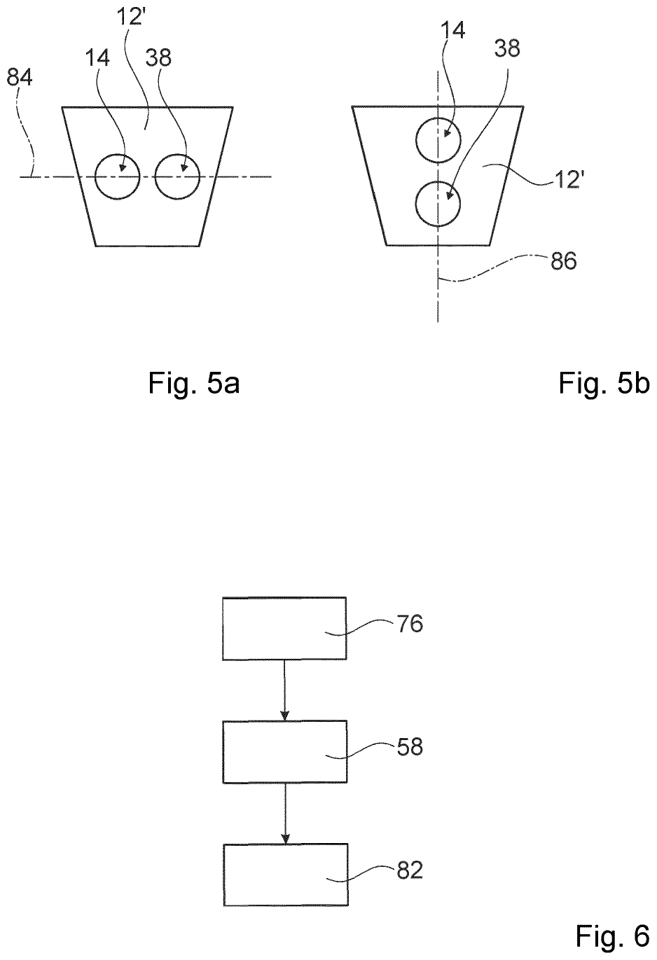

FIGS. 5a and 5b show schematic side views of alternative fluid receiving bodies 12′ of the functional component 10. The alternative fluid receiving bodies 12′have a different arrangement of the fluid inlet opening and/or fluid outlet opening 14 and of the further fluid inlet opening and/or fluid outlet opening 38. In these cases, the further fluid inlet opening and/or fluid outlet opening 38 is open to the same side 46 of the fluid receiving body 12′to which the fluid inlet opening and/or fluid outlet opening 14 is also open. In such a case, fluid inlet openings and/or fluid outlet openings 14 and further fluid inlet openings and/or fluid outlet openings 38 may be situated next to one another or one above the other in a common horizontal plane (84, FIG. 5a), which in particular extends parallel to the main extension direction of the carrier component 16, or in a further plane (86, FIG. 5b) which is angled, for example perpendicular, with respect to the horizontal plane 84.

FIG. 6 shows a schematic flow chart of a method for sealing the fluid channel 18 of the carrier component 16 with the fluid receiving body 12 by means of the fluid sealing system 44. In at least one method step 76, the sealing component 24, the functional component 10 with the fluid receiving body 12 and the carrier component 16 are provided. In at least one method step 58, the fluid receiving body 12 is pressed into the receiving recess 22 of the carrier component 16, said receiving recess 22 being connected with the fluid channel 18. Herein the sealing component 24 is elastically upset such that it bears sealingly against the surfaces 26, 28 of the fluid receiving body 12 and of the carrier component 16. The sealing surfaces 68, 70 of the sealing component 24, which is arranged obliquely with respect to the fitting direction 30 and encircles the fluid inlet opening and/or fluid outlet opening 14 of the fluid receiving body 12 in a circumferential direction, here bear exclusively against surfaces 26, 28 of the fluid receiving body 12 and of the carrier component 16, which are free of separating burrs and separating planes. In at least one further method step 82, the pressed-in functional component 10 is detachably fastened to the carrier component 16. This realizes the assembled state of the fluid sealing system 44. As a result of the fastening of the functional component 10 to the carrier component 16 in the method step 82, in the assembled state the force produced by the pressing-in, and thus a sealing effect of the sealing component 24, is maintained.

1. A fluid sealing system with at least one functional component comprising at least one fluid receiving body which has at least one fluid inlet opening and/or fluid outlet opening, with at least one carrier component which has at least one fluid channel comprising at least one fluid channel inlet opening and/or fluid channel outlet opening, which is configured to carry at least the functional component and which has at least one, in particular at least substantially trough-like, receiving depression for at least substantially precisely fitting accommodation of the functional component, and with at least one sealing component which forms sealing surfaces and which is configured to establish fluid tightness of a connection between the fluid inlet opening and/or fluid outlet opening and the fluid channel inlet opening and/or fluid channel outlet opening by means of the sealing surfaces, wherein at least the sealing surfaces of the sealing component bear exclusively against surfaces of the functional component, in particular of the fluid receiving body, and of the carrier component, which are free of separating burrs and separating planes.

2. The fluid sealing system according to claim 1, wherein the fluid receiving body and/or the carrier component are produced as, in particular one-piece, injection-molded parts.

3. The fluid sealing system according to claim 1, wherein the functional component, in particular the fluid receiving body, and the carrier component are realized so as to be separable from one another in a non-destructive manner.

4. The fluid sealing system according to claim 1, wherein the functional component, in particular the fluid receiving body, is pressed into the carrier component.

5. The fluid sealing system according to one claim 1, wherein the fluid inlet opening and/or fluid outlet opening of the fluid receiving body is arranged laterally with respect to a fitting direction along which the functional component is installed in the carrier component, and/or is arranged laterally with respect to a normal direction of a main extension plane of the carrier component.

6. The fluid sealing system according to claim 1, wherein an opening plane of the fluid inlet opening and/or fluid outlet opening of the fluid receiving body is angled relative to a fitting direction along which the functional component is installed in the carrier component, and/or is angled relative to a normal direction of a main extension plane of the carrier component.

7. The fluid sealing system according to claim 6, wherein an angle spanned by the opening plane and the fitting direction and/or the normal direction is between 2.5° and 22.5°, preferably between 5° and 15°.

8. The fluid sealing system according to claim 1, wherein the fluid receiving body has at least one further fluid inlet opening and/or fluid outlet opening, which is connectable in a fluid-tight manner to at least one further fluid channel inlet opening and/or fluid channel outlet opening of the carrier component or of a further carrier component via a further sealing component of the fluid sealing system in a manner that is at least substantially the same as in the connection of the fluid inlet opening and/or fluid outlet opening with the fluid channel inlet opening and/or fluid channel outlet opening.

9. The fluid sealing system according to claim 8, wherein a further fluid inlet opening and/or fluid outlet opening is open to a side of the fluid receiving body which is different from a further side of the fluid receiving body to which the fluid inlet opening and/or fluid outlet opening is open.

10. The fluid sealing system according to claim 8, wherein a further fluid inlet opening and/or fluid outlet opening is open to the same side of the fluid receiving body to which the fluid inlet opening and/or fluid outlet opening is also open.

11. The fluid sealing system according to claim 1, wherein the sealing component is embodied as an O-ring.

12. The fluid sealing system according to claim 1, wherein the fluid receiving body is fastened to the carrier component, in particular to a planar side of the carrier component, by means of releasable connection elements, such as screws.

13. The fluid sealing system according to one claim 1, wherein the functional component is realized as a valve, in particular a fluid valve, as a fluid sensor, as a pump or as a heat exchanger, preferably in a refrigeration cycle or in a cooling cycle.

14. The fluid sealing system according to claim 1, wherein the carrier component is realized as a common functional component carrier, in particular of a fluid cycle, preferably of a refrigeration cycle or of a cooling cycle, said common functional component carrier comprising at least one further functional component in addition to the functional component.

15. The fluid sealing system according to claim 1, wherein the fluid channel is at least partially formed directly by the carrier component.

16. A fluid cycle, in particular a refrigeration cycle or a cooling cycle, with a fluid sealing system according to claim 1.

17. A method for sealing a fluid channel of the carrier component with the fluid receiving body, in particular by means of a fluid sealing system according to claim 1, wherein in at least one method step the fluid receiving body is pressed into an, in particular at least substantially trough-like, receiving depression of the carrier component, which is connected to the fluid channel, such that sealing surfaces of at least one sealing component, which is arranged obliquely with respect to a fitting direction of the fluid receiving body and of the carrier component and encircles a fluid inlet opening and/or fluid outlet opening of the fluid receiving body, bear exclusively against surfaces of the fluid receiving body and of the carrier component, which are free of separating burrs and separating planes.
